(19) United States
(12) Patent Application Publication
(10) Pub. No.: US 2014/0004806 A1
(43) Pub. Date: Jan. 2, 2014

(54) SYSTEM AND METHOD FOR WIRELESS COMMUNICATIONS

(71) Applicant: Huawei Technologies Co., Ltd., Shenzhen (CN)

(72) Inventors: Yuan Zhou, Shenzhen (CN); Mingjie Dong, Shenzhen (CN); Rong Rong, Shenzhen (CN); Wei Zhang, Shanghai (CN)

(73) Assignee: Huawei Technologies Co., Ltd., Shenzhen (CN)

(21) Appl. No.: 13/966,983

(22) Filed: Aug. 14, 2013

Related U.S. Application Data
(63) Continuation of application No. PCT/CN2012/071333, filed on Feb. 20, 2012.

(30) Foreign Application Priority Data
Feb. 21, 2011 (CN) 201110043628.6

(51) Int. Cl. H04B 1/44

(52) U.S. Cl. CPC H04B 1/44
USPC 455/78

(57) ABSTRACT

A system and a method for wireless communications, where the system includes: an antenna subsystem, where the antenna subsystem includes at least one antenna unit, the antenna unit includes at least two antenna elements, at least one power splitter/combiner connected to the at least one antenna unit, and at least one switch unit correspondingly connected to the at least one power splitter/combiner, By adopting the method or the system in the embodiments of the present invention, network resources of switch units can be saved.

### CROSS-REFERENCE TO RELATED APPLICATION

This application is a continuation of International Application No. PCT/CN2012/071333, filed on Feb. 20, 2012, which claims priority to Chinese Patent Application No. 201110043628.6, filed on Feb. 21, 2011, both of which are hereby incorporated by reference in their entireties.

### TECHNICAL FIELD

The present invention relates to the field of communications technologies, and in particular, to a wireless communication system and a wireless communication method.

### BACKGROUND

With the continual improvement of a wireless local area network (Wireless Local Area Networks, WLAN) technology in mobility, speed, popularity, security, ease of use of multimedia, functions, and other items, the WLAN becomes an important technology in three informatization markets, namely, industry informatization market, home informatization market, and individual informatization market. Moreover, with the continual deepening of cable television network transformation, the WLAN also begins to be applied in core digital household devices such as a digital television and a set top box, and becomes an important technology of digital home networking. Further, as best supplement for 3G network coverage, the WLAN network also shows a competitive advantage of a lower price and a higher bandwidth.

The deployment of plenty of WLAN access point (Access Point, AP) nodes makes an AP suffer more and more interference in its application environment, while a WLAN device includes multiple antenna elements, and the device may intercommunicate with a wirelessly-connected communication network, where multiple antenna elements may be selectively coupled with an RF signal modulator through a switch unit. In the prior art, anti-interference is implemented through the switch unit. It is assumed that a first radio frequency (RF) signal reaches a first antenna element of the WLAN device, where the RF signal comes from the wirelessly-connected communication network and is a wanted signal; and a second RF signal reaches a second antenna element of the wireless local area network device, where the RF signal is an unwanted signal. And then, the second signal interferes with the first signal. A second antenna unit may be disconnected from a RF demodulator through disconnecting a switch network which is connected with the second antenna element; in this way, the wireless local area network device cannot receive the second signal, and therefore the interference is reduced.

However, in the prior art, the antenna element is connected to the switch unit in one-to-one-connected correspondence, which requires each antenna element to have a switch unit to control opening and closing of the antenna, thereby causing relatively high costs of switch units and causing waste of network resources of switch units.

### SUMMARY

Embodiments of the present invention provide a system and a method for wireless communications, so as to solve a problem in the prior art that waste of network resources of switch units is caused due to relatively high costs of the switch units.

To solve the foregoing technical problem, an embodiment of the present invention provides a wireless communication system, including:

an antenna subsystem, where the antenna subsystem includes at least one antenna unit, the antenna unit includes at least two antenna elements, and the antenna elements are configured to radiate or receive wireless communication signals;

at least one power splitter/combiner connected to the at least one antenna unit, where the at least one power splitter/combiner is configured to combine the wireless communication signals radiated by the at least two antenna elements which are included by the antenna unit, or divide a received wireless communication signal into at least two wireless communication signals on average; and

at least one switch unit correspondingly connected to the at least one power splitter/combiner, where the at least one switch unit is configured to perform switch control on the wireless communication signals radiated or received by the antenna unit.

An embodiment of the present invention provides a wireless communication method, including:

radiating or receiving, by an antenna element, wireless communication signals, where at least two antenna elements form an antenna unit, and at least one antenna unit forms an antenna subsystem;

combining, by at least one power splitter/combiner connected to the at least one antenna unit, the wireless communication signals radiated by the at least two antenna elements which are included by the antenna unit, or dividing a received wireless communication signal into at least two wireless communication signals on average; and

performing, by at least one switch unit correspondingly connected to the at least one power splitter/combiner, switch control on the wireless communication signals radiated or received by the antenna unit.

Embodiments of the present invention have the following advantages:

In the embodiments of the present invention, by using a power splitter/combiner, multiple antenna elements can be enabled to connect to one switch unit, thereby saving costs of switch units, and also saving network resources of the switch units.

### BRIEF DESCRIPTION OF THE DRAWINGS

To illustrate the technical solutions in the embodiments of the present invention or in the prior art more clearly, the accompanying drawings required for describing the embodiments or the prior art are introduced briefly in the following. Apparently, the accompanying drawings in the following description are only some embodiments of the present invention, and persons of ordinary skill in the art can further derive other drawings according to these accompanying drawings without creative efforts.

FIG. 1 is a schematic structural diagram of an embodiment of a wireless communication system according to the present invention;

FIG. 2, FIG. 3, and FIG. 4 are schematic diagrams of arrangement manners of antenna elements according to an embodiment of a wireless communication system;

FIG. 5 is a schematic diagram of fixed directional antennas according to an embodiment of a wireless communication system;

FIG. 6 is a schematic diagram of a three-dimensional structure of antenna elements of multiple antenna channels;

FIG. 7 is a schematic structural diagram of new 360-degree omnidirectional coverage formed by six omnidirectionally radiating antenna elements; and

FIG. 8 is a flow chart of an embodiment of a wireless communication method according to the present invention.

### DETAILED DESCRIPTION

The technical solutions in embodiments of the present invention are described clearly and completely with reference to the accompanying drawings in the embodiments of the present invention in the following. Apparently, the described embodiments are only some embodiments of the present invention, rather than all embodiments. All other embodiments obtained by persons of ordinary skill in the art based on the embodiments of the present invention without creative efforts shall fall within the protection scope of the present invention.

In order to make the foregoing objectives, characteristics, and advantages of the embodiments of the present invention more obvious and comprehensible, the embodiments of the present invention are further illustrated in detail in the following with reference to the accompanying drawings and specific implementation manners.

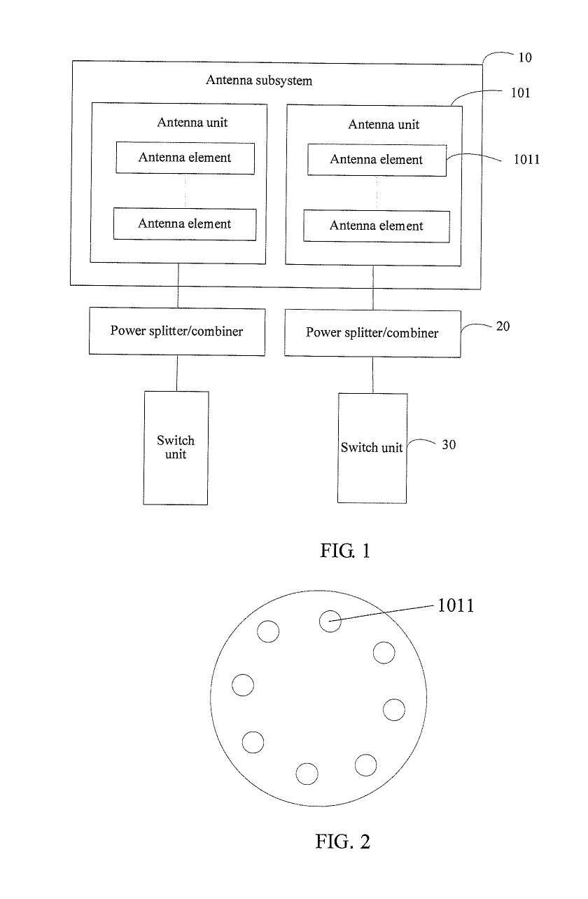

Referring to FIG. 1, in an embodiment of the present invention, a wireless communication system provided in the embodiment of the present invention may include the following devices:

an antenna subsystem 10, where the antenna subsystem may include at least one antenna unit 101, the antenna unit may include at least two antenna elements 1011, and the antenna elements 1011 may be specifically configured to radiate or receive wireless communication signals;

at least one power splitter/combiner 20 connected to the at least one antenna unit, where the at least one power splitter/combiner 20 may be configured to combine the wireless communication signals radiated by the at least two antenna elements 1011 which are included by the antenna unit 101, or divide a received wireless communication signal into at least two wireless communication signals on average; and
at least one switch unit 30 correspondingly connected to the at least one power splitter/combiner 20, where the at least one switch unit 30 may perform switch control on the wireless communication signals radiated or received by the antenna unit 101.

Because the power splitter/combiner 20 is adopted, the wireless communication signals radiated by multiple antenna elements 1011 may be combined to form one wireless communication signal, so that the number of switch units 30 connected to the antenna unit which is formed by the multiple antenna elements 1011 can be reduced, thereby saving network resources of switches.

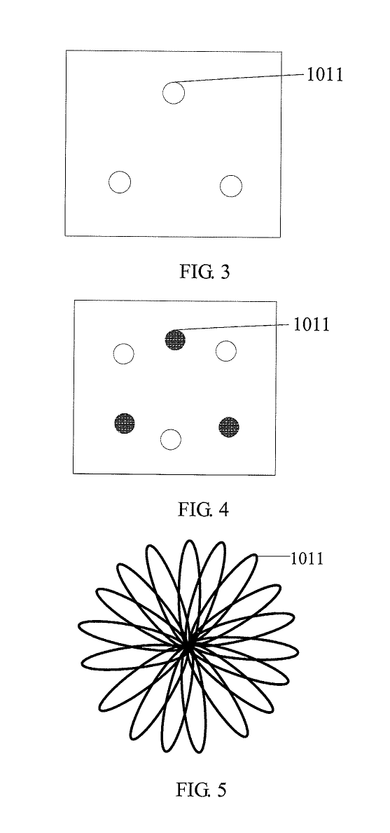

In a practical application, antenna units of each channel in the antenna subsystem may be placed on a substrate. Referring to what is shown in FIG. 2, the antenna elements 1011 are arranged in a manner of forming a circle. Meanwhile, referring to what is shown in FIG. 3, three antenna elements 1011 are arranged in a manner of a triangle. Besides, antenna units of multiple antenna channels may be designed into a planar structure, and antenna elements of multiple channels are in a same plane. Referring to what is shown in FIG. 4, three circles which are in a white background and presents an inverted triangle are antenna elements 1011, at the same time, three circles which are in a black background and present an equilateral triangular shape are also antenna elements, and the antenna elements 1011 which are in different background colors are on different channels. However, it should be noted that, an arrangement manner of antenna elements are not limited to several shapes shown in FIG. 2, FIG. 3, and FIG. 4. Any arrangement manner is feasible as long as it satisfies that all the antenna elements in the antenna subsystem are ensured to be in the same plane.

In addition, antenna elements on antenna units of each channel of the antenna subsystem may adopt any linear polarization manner, and the polarization manner of the antenna elements also has no influence on the implementation of the embodiment of the present invention.

In the practical application, the antenna unit or antenna element on each channel may be connected to a parasitic element, where the parasitic element may optimize the performance of the antenna element through technologies such as reflection or guiding. Meanwhile, each antenna element in the antenna subsystem may adopt a directional antenna shown in FIG. 5. A certain direction difference exists between each antenna element, and multiple antenna elements jointly form 360-degree omnidirectional coverage.

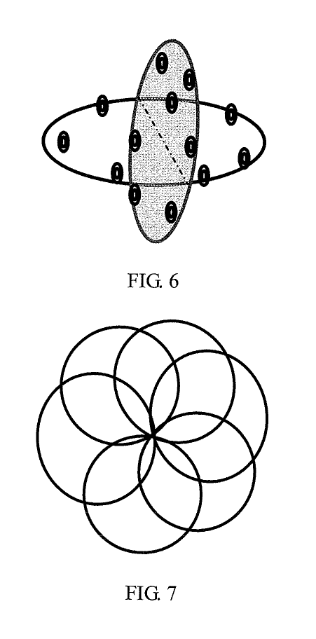

It should be noted that, antenna units of multiple antenna channels may present a three-dimensional structure, that is, antenna elements of multiple channels should be in different planes. Referring to what is shown in FIG. 6, it is a schematic diagram of a three-dimensional structure of antenna elements of multiple antenna channels. Definitely, in the practical application, a practical three-dimensional structure may be diversified.

In specific implementation of the antenna subsystem, all the antenna elements included by the antenna units of each channel in the antenna subsystem adopt directions of omnidirectional radiation, and multiple omnidirectionally radiating antenna elements can form new 360-degree omnidirectional coverage. Referring to what is shown in FIG. 7, it is a schematic structural diagram of new 360-degree omnidirectional coverage formed by six omnidirectionally radiating antenna elements.

For the at least one switch unit 30, when performing switch control on the wireless communication signals radiated or received by the antenna unit 101, it needs to externally receive a control instruction. For example, when a ratio which is of wanted signals to unwanted signals and is on the antenna unit 101 connected to a certain switch unit 30 is larger than a certain threshold, or the antenna unit 101 connected to a certain switch unit 30 radiates or receives unwanted signals, a closing instruction is sent to the switch unit 30 to close signal transmitting or receiving of the antenna unit which is connected to the switch unit.

In the embodiment of the present invention, the foregoing disclosed directional antenna elements which may be controlled selectively can solve a problem that when a WLAN system is applied in an environment where interference exists, such as a home environment, interference is caused due to communication of another AP or STA; and can avoid receiving signals from a direction of an interference source and reduce interference of another system, thereby improving indoor system capacity of a WLAN network.

For the obtaining the ratio which is of wanted signals to unwanted signals and is on the antenna unit 101, the following manner may be adopted for implementing:

According to a packet error rate (PER) and rate information of an upper layer receiving a packet, throughput on a corresponding antenna unit maybe obtained. When the throughput of signals received by the corresponding antenna unit is lower than a certain preset threshold, the signal on the antenna unit is determined to be an unwanted signal. It should be noted that, in this case, although the signal on the antenna unit is determined to be the unwanted signal, actually there are more unwanted signals than wanted signals among the received signals, so that a PER value increases when bit error occurs during upper-layer decoding, which further leads to decreasing of modulation and coding rate. And therefore, the throughput is relatively low. The throughput=rate×(1−PER). On the contrary, if the throughput is larger than the certain preset threshold, it is considered that the signal received by the antenna unit is a wanted signal, because the larger the throughput is, the better the quality of communication between the corresponding antenna unit and a terminal is.

In addition, the power splitter/combiner in the embodiment of the present invention may be implemented by adopting a microstrip which is printed on a circuit board, that is, the power splitter/combiner is connected to antenna elements in antenna units on multiple channels by adopting a microstrip form. Definitely, the power splitter/combiner may be in a one-to-two mode, and may also be in any one-to-multiple mode. Moreover, the power splitter/combiner may be integrated with a backend switch unit to be a component, that is, the power splitter is implemented through adopting a separate component, which may be in the one-to-two mode, and may also be in any one-to-multiple mode. The power splitter/combiner may be connected to antenna elements in antenna arrays on multiple channels by adopting coaxial cables, or the power splitter/combiner may also be connected to a backend switch control network by adopting coaxial cables.

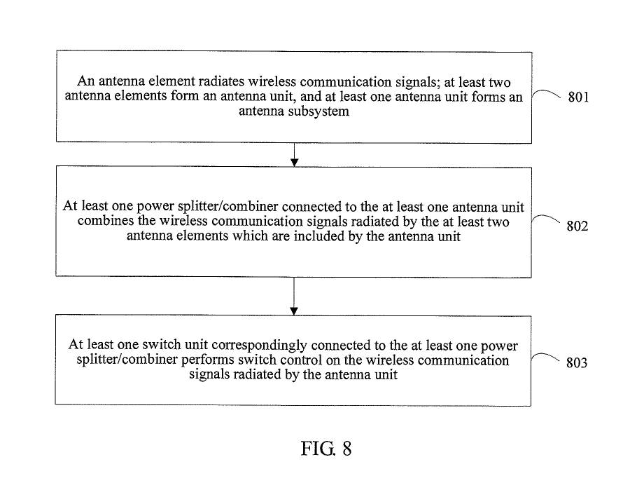

Referring to what is shown in FIG. 8, it shows a flow chart of an embodiment of a wireless communication method according to the present invention, where the method may include:

Step 801: An antenna element radiates wireless communication signals; at least two antenna elements form an antenna unit, and at least one antenna unit forms an antenna subsystem.

It should be noted that, the antenna elements may also receive wireless communication signals from a power splitter/combiner.

Step 802: At least one power splitter/combiner connected to the at least one antenna unit combines the wireless communication signals radiated by the at least two antenna elements which are included by the antenna unit.

It should be noted that, when the antenna elements receive wireless communication signals, the power splitter/combiner needs to divide a received wireless communication signal into at least two wireless communication signals on average and transmit them to each antenna unit.

Step 803: At least one switch unit correspondingly connected to the at least one power splitter/combiner performs switch control on the wireless communication signals radiated by the antenna unit.

It should be noted that, the at least one switch unit correspondingly connected to the at least one power splitter/combiner may also perform switch control on the wireless communication signals received by the antenna unit.

It should be noted that, for ease of description, the foregoing method embodiment is described as a series of action combinations, but persons skilled in the art should know that, the present invention is not limited to the described action sequence, because according to the present invention, certain steps may adopt another sequence or may be performed simultaneously. Then, persons skilled in the art should also know that the described embodiments in the specification all belong to exemplary embodiments, and the involved actions and modules are not necessarily required by the present invention.

It should be noted that, each embodiment in the specification is described by adopting a progressive manner. Each embodiment focuses on its differences from other embodiments, and for a same or similar part, mutual reference may be made between each embodiment. For the method embodiment, because it is basically similar to the system embodiment, it is described rather briefly, and for the relevant parts, reference may be made to some descriptions of the system embodiment.

It should be further noted that, in this specification, the terms “include”, “including” or any other variation meaning of them are intended to cover a non-exclusive inclusion, so that a process, method, article, or device that includes a series of elements not only includes those elements, but also includes other elements which are not explicitly listed, or further includes elements which are inherent in such process, method, article or device. Ina case without more limits, an element restricted by a sentence “includes a . . . ” does not exclude the existence of additional same elements in the process, method, article, or device that includes the element.

Persons of ordinary skill in the art may understand that all or a part of the steps of each method in the foregoing embodiments may be accomplished by a program instructing relevant hardware. The program may be stored in a computer readable storage medium. The storage medium may include a ROM, a RAM, a magnetic disk, or a compact disk, and so on.

The system and the method for wireless communications provided in the embodiments of the present invention are introduced in detail in the foregoing. Principles and implementation manners of the present invention are illustrated in the specification by applying specific examples. The description about the foregoing embodiments is merely used to help understand the method and ideas of the embodiments of the present invention. Meanwhile, persons of ordinary skill in the art can make variations to specific implementation manners and application scopes according to the ideas of the embodiments of the present invention. In conclusion, the content of the specification shall not be understood as a limit to the present invention.

What is claimed is:

1. A wireless communication system, comprising:
an antenna subsystem, wherein the antenna subsystem comprises at least one antenna unit, the antenna unit comprises at least two antenna elements, and the antenna elements are configured to radiate or receive wireless communication signals;
at least one power splitter/combiner connected to the at least one antenna unit, wherein the at least one power splitter/combiner is configured to combine at least two wireless communication signals radiated by the at least two antenna elements which are comprised by the antenna unit, or divide a received wireless communication signal into at least two wireless communication signals on average; and
at least one switch unit correspondingly connected to the at least one power splitter/combiner, wherein the at least one switch unit is configured to perform switch control on the wireless communication signals radiated or received by the antenna unit.

2. The wireless communication system according to claim 1, wherein the antenna elements in each antenna unit adopt a planar structure, and a same planar structure indicates that all the antenna elements in different antenna units are in one plane;
or, the antenna elements in each antenna unit adopt a three-dimensional structure, and the three-dimensional structure indicates that at least two antenna elements in different antenna units are in different planes, respectively.

3. The wireless communication system according to claim 1, wherein a polarization manner of the antenna element is a linear polarization manner.

4. The wireless communication system according to claim 1, wherein the antenna element is further connected to a parasitic element.

5. The wireless communication system according to claim 4, wherein the antenna element and the parasitic element which is connected to it are printed on a same substrate.

6. The wireless communication system according to claim 4, wherein the antenna element and the parasitic element which is connected to it are soldered on a same substrate.

7. The wireless communication system according to claim 1, wherein the antenna elements are omnidirectional antennas.

8. The wireless communication system according to claim 1, wherein the antenna elements are fixed directional antennas, and the antenna subsystem is an omnidirectional-coverage antenna system jointly formed by the fixed directional antennas.

9. The wireless communication system according to claim 1, wherein the connection between the power splitter/combiner and the switch unit is implemented by adopting a discrete component.

10. A wireless communication method, comprising:
radiating or receiving, by an antenna element, wireless communication signals, wherein at least two antenna elements form an antenna unit, and at least one antenna unit forms an antenna subsystem;
combining, by at least one power splitter/combiner connected to the at least one antenna unit, at least two wireless communication signals radiated by the at least two antenna elements which are comprised by the antenna unit, or dividing a received wireless communication signal into at least two wireless communication signals on average; and
performing, by at least one switch unit correspondingly connected to the at least one power splitter/combiner, switch control on the wireless communication signals radiated or received by the antenna unit.
